(19) United States
(12) Patent Application Publication
(10) Pub. No.: US 2014/0108475 A1
(43) Pub. Date: Apr. 17, 2014

(54) MIGRATION-DESTINATION FILE SERVER AND FILE SYSTEM MIGRATION METHOD

(71) Applicants: Kumiko Yamada, Fujisawa (JP); Hitoshi Arai, Chigasaki (JP); Shinya Matsumoto, Yokohama (JP)

(72) Inventors: Kumiko Yamada, Fujisawa (JP); Hitoshi Arai, Chigasaki (JP); Shinya Matsumoto, Yokohama (JP)

(73) Assignee: HITACHI, LTD., Tokyo (JP)

(21) Appl. No.: 13/643,449

(22) PCT Filed: Oct. 11, 2012
(86) PCT No.: PCT/JP2012/006536

§ 371 Date: Dec. 6, 2012

(51) Int. Cl. G06F 17/30

(52) U.S. Cl. CPC G06F 17/30289
USPC 707/829

(57) ABSTRACT

A migration-destination file server is coupled to a migration-source file server that provides a migration-source file system, and provides a migration-destination file system. The migration-destination file server comprises a storage device and a controller. When migrating a first hard-linked file, which is included in multiple hard-linked files referencing the same file management information in the migration-source file system, to the migration-destination file system, the controller stores data related to the first hard-linked file in the storage device, creates the first hard-linked file in the migration-destination file system, and creates a dummy hard-linked file for referencing the same file management information as the first hard-linked file in the migration-destination file server, and when migrating a second hard-linked file included in the multiple hard-linked files, the controller renames the dummy hard-linked file as a pathname of the second hard-linked file in the migration-destination file system.

### TECHNICAL FIELD

The present invention relates to technology for migrating a file system which is provided by a migration-source file server to a migration-destination file server.

### BACKGROUND ART

Heretofore, a file server on which is constructed a file system for managing various types of data as files has been known. A hard-linked file, which is a file for referencing the same physical storage area (file entity) as another file, may be managed in the file system. There may also be cases where a file system constructed on a file server has to be migrated to another file server.

Patent Literature 1, for example, discloses technology related to the migration of a hard-linked file when migrating a file system to another file system. Specifically, Patent Literature 1 discloses that, in a case where hard link information of the same inode number as migration target hard-linked file is registered in a hard link information list when migrating hard-linked file from a migration-source file system to a migration-destination file system, a hard-linked file corresponding to a filename included in the hard link information is created in a directory tree of the migration-destination file system.

### CITATION LIST

### Patent Literature

PTL 1: WO 2007/099636

### SUMMARY OF INVENTION

### Technical Problem

A file managed in a file system is required to be able to be used when the file system is being migrated.

For example, in the technology disclosed in Patent Literature 1, when a file registered in a hard link information list is deleted or renamed in the migration-destination file system, the hard link information list cannot be used to appropriately migrate a hard-linked file, which references the same physical storage area as this file and has not yet to be migrated to the migration-destination file system, to the migration-destination file system. The problem, therefore, is that it is not possible for the migration-destination file system to delete or rename a file registered in the hard link information list during migration of the hard-linked file.

### Solution to Problem

A migration-destination file server related to one aspect of the present invention is coupled to a migration-source file server that provides a migration-source file system, and provides a migration-destination file system. The migration-destination file server comprises a storage device and a controller. When migrating a first hard-linked file, which is included in multiple hard-linked files referencing the same file management information in the migration-source file system, to the migration-destination file system, the controller stores data related to the first hard-linked file in the storage device, creates the first hard-linked file in the migration-destination file system, and creates a dummy hard-linked file for referencing the same file management information as the first hard-linked file in the migration-destination file server, and when migrating a second hard-linked file included in the multiple hard-linked files, the controller renames the dummy hard-linked file as a pathname of the second hard-linked file in the migration-destination file system.

### Advantageous Effects of Invention

According to the present invention, it is possible to appropriately execute at least one of a delete process or a rename process with respect to a hard-linked file migrated to a file system in the migration-destination file server even while the file system migration is in progress.

### BRIEF DESCRIPTION OF DRAWINGS

FIG. 1 is a first diagram showing an overview of a file system migration process related to Example 1.

FIG. 2 is a second diagram showing an overview of a file system migration process related to Example 1.

FIG. 3 is a block diagram of a computer system related to Example 1.

FIG. 4 is a block diagram of an inode related to Example 1.

FIG. 5 is a diagram illustrating an inode list and a data block related to Example 1.

FIG. 6 is a flowchart showing an example of an entire file system migration process related to Example 1.

FIG. 7 is a flowchart showing an example of a migration process related to Example 1.

FIG. 8 is a flowchart showing an example of an inode number database query process related to Example 1.

FIG. 9 is a flowchart showing an example of a hard link migration (normal file handling) process related to Example 1.

FIG. 10 is a flowchart showing an example of a hard link migration (hard link handling) process related to Example 1.

FIG. 11 is a diagram illustrating a rename process related to Example 1.

FIG. 12 is a flowchart showing an example of an I/O, rename, and delete process during a migration related to Example 1.

FIG. 13 is a first diagram showing an overview of a file system migration process related to Example 2.

FIG. 14 is a second diagram showing an overview of a file system migration process related to Example 2.

FIG. 15 is a flowchart showing an example of a migration process related to Example 2.

FIG. 16 is a flowchart showing an example of an inode number database query process related to Example 2.

FIG. 17 is a flowchart showing an example of a hard link migration (normal file handling) process related to Example 2.

FIG. 18 is a flowchart showing an example of a hard link migration (hard link handling) process related to Example 2.

FIG. 19 is a flowchart showing an example of a rename process during migration related to Example 2.

### DESCRIPTION OF EMBODIMENTS

A number of examples of the present invention will be explained by referring to the drawings. The examples explained below do not limit the invention related to the claims, and not all of the elements and combinations thereof explained in the examples are essential for the solution provided by the invention.

In the following explanation, information of the present invention is explained using expressions such as “aaa list”, but this information may also be expressed using a data structure other than a list. Therefore, to show that this information is not dependent on the data structure, “aaa list” may be called “aaa information”.

When explaining the contents of the respective information, the expression “number” is used, but this expression is interchangeable with the expressions “identification information”, “identifier”, and “name”.

In the following explanation, there may be cases where an explanation is given using a “program” as the doer of the action, but since the stipulated processing is performed in accordance with a program being executed by a processor (typically, a CPU (Central Processing Unit)) while using a memory and an I/F (interface), the explanation may have the processor as the doer of the action. A process, which is disclosed as having the program as the doer of the action, may be regarded as a process performed by a file server or other such computer. Furthermore, either all or a portion of a program may be realized in accordance with dedicated hardware. Various types of programs may be installed in respective computers using a program distribute server or computer readable storage media. The storage media, for example, may include an IC card, a SD card, a DVD, and the like.

Furthermore, in the following explanation, “hard link” signifies a file, which has the same file management information identifier as another hard link and references the same physical storage area (for example, a file entity of this area), and can be referred to as a hard-linked file (hard linked file) or a file having a hard link attribute. Also, “inode” is an example of file management information, and “inode number” is an example of a file management information identifier. In addition, “link” can also be referred to as reference (reference) or pointer (Pointer).

Example 1 related to the present invention will be explained.

First, an overview of a computer system related to Example 1 will be explained.

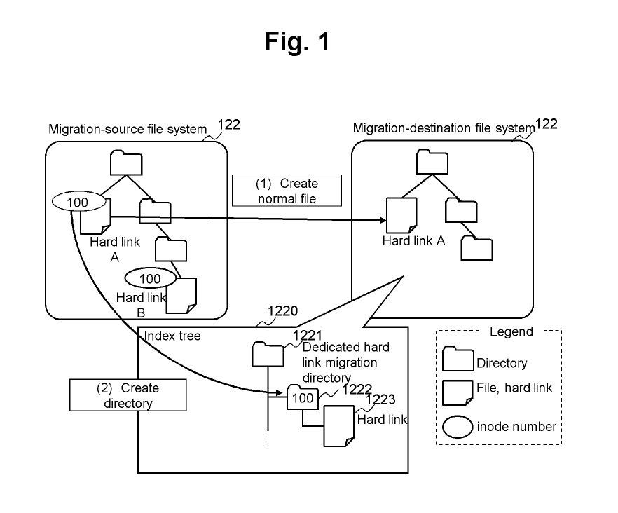

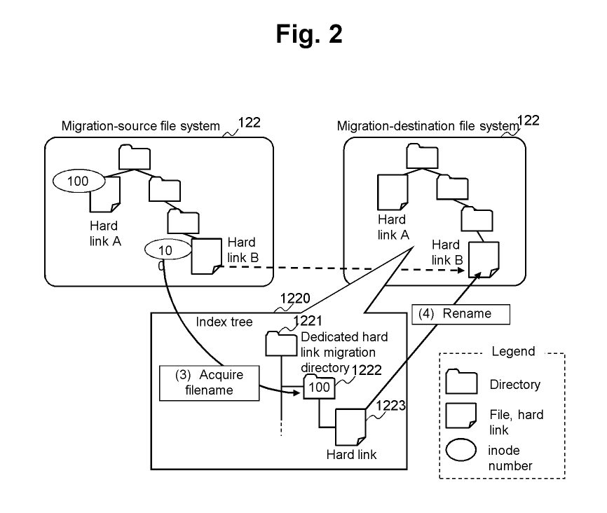

FIG. 1 is a first diagram showing an overview of a file system migration process related to Example 1. FIG. 2 is a second diagram showing an overview of a file system migration process related to Example 1. FIGS. 1 and 2 show examples of a case in which a file system (referred to as migration-source file system) 122 of a migration-source file server 20 is migrated to a file system (referred to a migration-destination file system) 122 of a migration-destination file server 10.

A hard link A and a hard link B, which reference the same physical storage area (that is, the same file entity), are managed in the migration-source file system 122. The hard link A and the hard link B are managed here as having (referencing) the same inode number (“100” here).

First, in a case where the hard link A is migrated to the migration-destination file system 122, the migration-destination file server 10 migrates the hard link A to the migration-destination file system 122 the same as a normal file migration as shown in FIG. 1 (1). Specifically, the migration-destination file server 10 stores the file entity referenced by the hard link A in a user data storage apparatus 150 of the migration-destination file server 10, creates and stores an inode corresponding to the hard link A. Then the migration-destination file server 10 associatively registers the hard link A filename with a migration-destination file system 122 inode number allocated to the relevant hard link A in a directory file corresponding to a migration-destination directory in the migration-destination file system 122. The migration-destination file server 10 thereafter associatively stores the allocated inode number and data block information showing the address of the data block, which stores the file entity, in an inode list 170.

Next, as shown in FIG. 1 (2), the migration-destination file server 10 creates a directory 1222, which has the migration-source file system 122 inode number (“100” here) associated with the migration-target hard link A as the directory name, under a dedicated hard link directory 1221. Further, the migration-destination file server 10 creates a hard link (referred to as either a dummy hard link or a link-source file) 1223 associated with the migration-destination file system 122 inode number of the hard link A under the directory 1222. The filename of the hard link 1223 here may be an arbitrary name. In this example, the migration-destination file server 10 creates one less hard link 1223 than the number of links included in the inode 160 of the migration-target hard link A. In other words, the migration-destination file server 10 creates dummy hard links in the number corresponding to the number of the hard links that have not been migrated from the migration-source file system to the migration-destination file system.

Thereafter, in a case where a hard link B for referencing the same file entity as the hard link A is migrated to the migration-destination file system 122, as shown in FIG. 2 (3), the migration-destination file server 10 acquires the inode number of the hard link B in migration-source file system 122 and the filename of the hard link B. Then the migration-destination file server 10 identifies the hard link 1223 subordinate to the dedicated hard link migration directory 1221 of the migration-destination file system 122 and subordinate to the directory 1222 having the acquired inode number as the directory name.

Next, the migration-destination file server 10, as shown in FIG. 2 (4), renames the identified hard link pathname as the acquired pathname. Specifically, the migration-destination file server 10 stores the hard link in a directory file 181, which corresponds to the migration-destination file system 122 migration destination directory corresponding to the acquired hard link B pathname. Since the same inode number as that of the hard link A in the migration-destination file system is associated with the hard link here, the same inode number as that of the hard link A in the migration-destination file system is associated with the post-rename hard link B. The same file entity as the hard link A is able to be referenced via this hard link B.

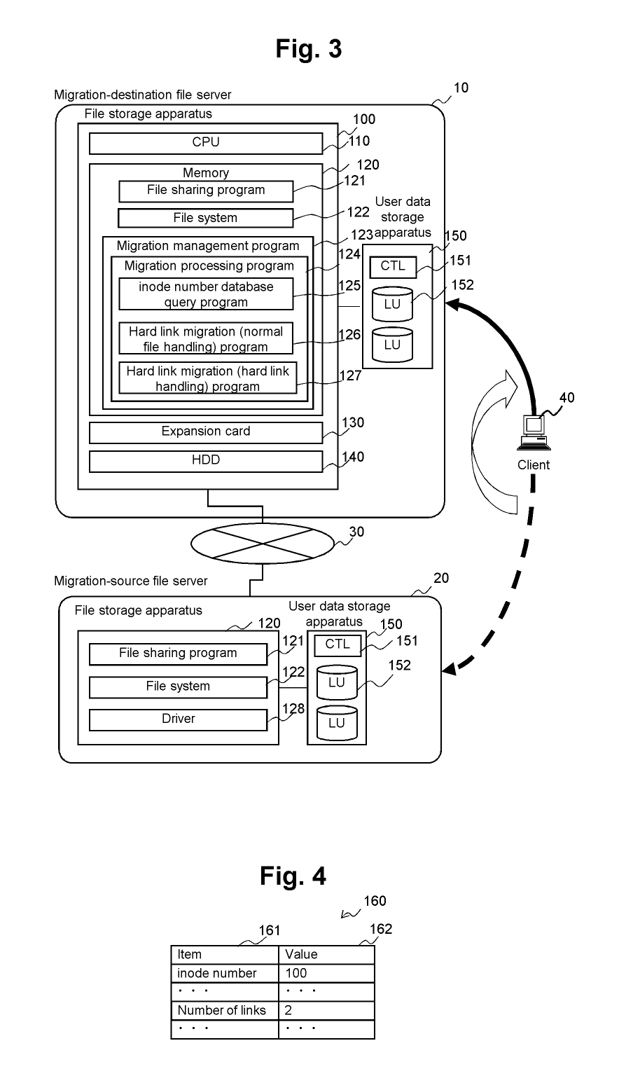

FIG. 3 is a block diagram of a computer system related to Example 1.

The computer system related to Example 1 includes a migration-source file server 20, a migration-destination file server 10, and a client 40. The migration-source file server 20 and the migration-destination file server 10, for example, are coupled via an IP network or other such communication network 30. The client 40 is coupled to the migration-source file server 20 and the migration-destination file server 10 via a communication network. The client 40 sends requests for various types of processing with respect to a file managed by file systems 122 constructed in the migration-source file server 20 and the migration-destination file server 10.

The migration-destination file server 10 includes a file storage apparatus 100 and a user data storage apparatus 150.

The file storage apparatus 100, for example, is a general-purpose computer, and includes a CPU (Central Processing Unit) 110, a memory 120, an expansion card 130, and a HDD (Hard Disk Drive) 140. Here the file server may be referred to as a file controller or a controller.

The CPU 110 executes various programs stored in the memory 120. The expansion card 130, for example, includes a communication I/F (interface), and carries out communications with another apparatus via the communication network 30. The HDD 140 stores various programs and various kinds of information.

The memory 120 stores various programs, and data which is used in various processes. The memory 120 stores a file sharing program 121, a file system 122, and a migration management program 123.

The file sharing program 121 is a program for realizing a function of sharing files managed by the file system 122 (a function of sharing files by multiple clients). The file sharing program 121 is, for example, a NFS (Network File System) or a CIFS (Common Internet File System). The file system 122 is a program for managing a file. The file system 122 manages a file using an inode, which is file management information for managing a file and a directory, an inode list 170, and a data block 180.

The migration management program 123 includes a migration processing program 124. The migration processing program 124 is for executing processing for migrating one file system to another file system, and includes an inode number database query program 125, a hard link migration (normal file handling) program 126, and a hard link migration (hard link handling) program 127.

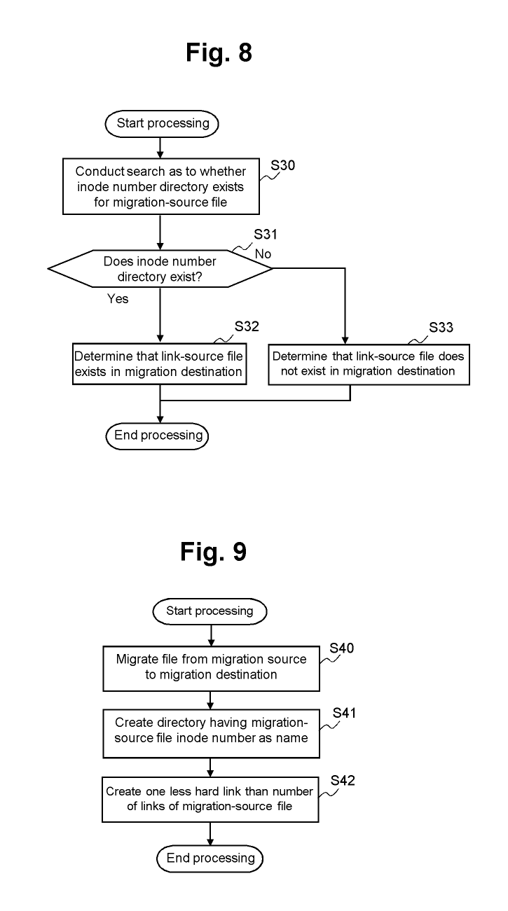

The inode number database query program 125 is for executing an inode number database query process (refer to FIG. 8) for determining whether or not a file corresponding to a prescribed inode number in a migration-source file system 122 is migrated to a migration-destination file system 122.

The hard link migration (normal file handling) program 126 is for executing a migration process (a hard link migration (normal file handling) process: refer to FIG. 9) with respect to a hard link migrated the earliest to the migration-destination file system from among multiple hard links associated with the same inode number in the migration-source file system 122.

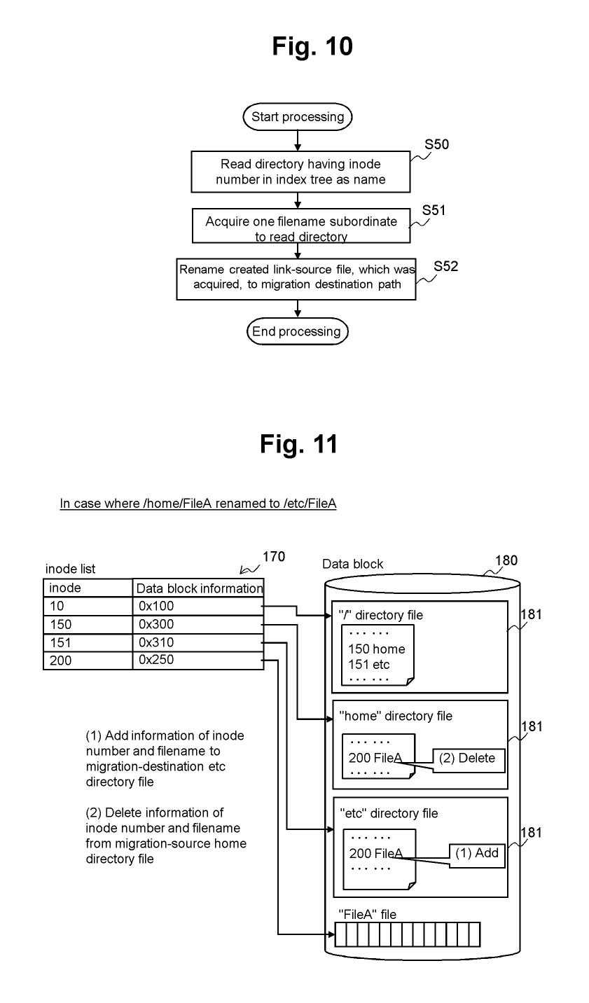

The hard link migration (hard link handling) program 127 is for executing a migration process (a hard link migration (hard link handling) process: refer to FIG. 10) with respect to a hard link migrated second or thereafter to the migration-destination file system from among multiple hard links associated with the same inode number in the migration-source file system 122.

The user data storage apparatus 150 includes a controller (CTL) 151, and one or more logical units (LU) 152. The LU 152 comprises a storage area of one or more storage devices, and stores various data. The storage device, for example, may be a HDD or a SSD (Solid State Drive). The CTL 151 performs a data access with respect to a LU 152 based on an IO request from the file storage apparatus 100. The various data stored by the user data storage apparatus 150 may be stored in the HDD 140 of the file storage apparatus 100, and when this is the case, the user data storage apparatus 150 need not be provided.

The migration-source file server 20 is substantially the same configuration as the migration-destination file server 10. In FIG. 3, a portion of the configuration of the migration-source file server 20 has been omitted. The driver 128 of the migration-source file server 20 is a program for controlling hardware.

FIG. 4 is a block diagram of an inode related to Example 1.

The inode 160 is provided corresponding to either a file or a directory, and is management information (file management information) for managing either a file or a directory. The inode 160, for example, is stored in the user data storage apparatus 150. At least a portion of the data of the inode 160 may be stored in either the HDD 140 or the memory 120. The inode 160 stores an item 161 and a value 162, which corresponds to this item. For example, the inode 160 stores the value of an inode number for identifying an inode, and the value (link information) of the number of files (number of links) associated with the relevant inode. The fact that the number of links in the inode 160 is equal to or larger than 2 here signifies that multiple files are associated with the relevant inode 160, that is, that a hard link exists.

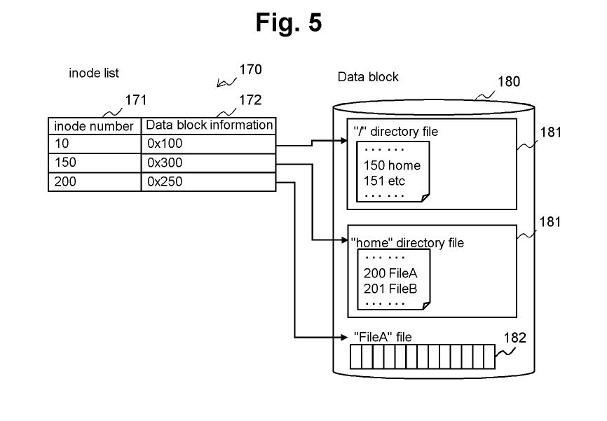

FIG. 5 is a diagram illustrating an inode list and a data block related to Example 1.

The inode list 170, for example, is stored in the user data storage apparatus 150. The inode list 170 associatively stores an inode number 171 and data block information 172.

The inode number 171 is an inode number denoting an inode. The data block information 172 is information denoting the location in the data block 180 in which an entity (a directory file 181 or a file entity 182) corresponding to the inode number is stored.

The data block 180 stores the file and directory entities managed by the file system 122. The data block 180, for example, is stored in the user data storage apparatus 150. The data block 180 stores one or more directory files 181, and one or more file entities 182. The directory file 181 corresponds to one directory, and stores a combination of the name of either a directory or file subordinate to this directory and the inode number of the inode 160 corresponding thereto. For example, according to FIG. 5, it is clear that the inode number of the inode 160 of the file or directory having the name “FileA” is “200”, and that the inode number of the inode 160 of the file or directory having the name “FileB” is “201”. The file entity 182 is a data entity managed as a file.

Next, processing using the computer system related to Example 1 will be explained.

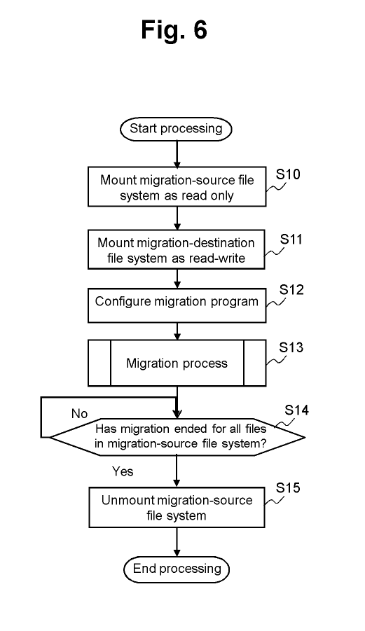

FIG. 6 is a flowchart showing an example of an entire file system migration process related to Example 1.

First, the computer system administrator mounts the migration-source file system 122 of the migration-source file server 20 to the client 40 as read only (Step S10). This makes it possible to ensure the matching of the migration-source file system 122 and the migration-destination file system 122 with respect to the same file since the file of the migration-source file system 122 does not change. Next, the computer system administrator mounts the migration-destination file system of the migration-destination file server 10 to the client 40 as read-write (Step S11).

Next, the administrator configures the migration-source file system and the migration-destination file system for the migration management program 123 of the migration-destination file server 10 (Step S12). Steps S10 through S12 may be automatically executed by the computer system.

Thereafter, the administrator (or the computer system) starts executing the migration management program 123 on the migration-destination file server 10, and starts executing a file system migration process using the file migration processing program 124 of the migration-destination file server 10. At this time, the administrator (or the computer system) performs a setting in the client 40 for switching the destination of various types of processing requests (for example, a file input/output request and so forth) related to a file in the migration-source file system 122 of the migration-source file server 20 to the migration-destination file system of the migration-destination file server 10.

The migration processing program 124 of the migration-destination file server 10 executes processing (migration processing) for migrating the migration-source file system to the migration-destination file system (Step S13). The migration processing is processing for migrating a file of the migration-source file system to the migration-destination file system. At this point in this migration process, each file of the migration-source file system may be sequentially selected and migrated as a migration-target file in the background (unrelated to a file access). Alternatively, each time a file is accessed by the client 40, the file targeted for access may be migrated.

Next, the migration processing program 124 of the migration-destination file server 10 determines whether or not the migrations of all the files in the migration-source file system have ended (Step S14), and in a case where the migrations have ended (Step S14: Yes), notifies the administrator (or the computer system) to this effect. Thereafter, the administrator (or the computer system) unmounts the migration-source file system from the client 40 (Step S15).

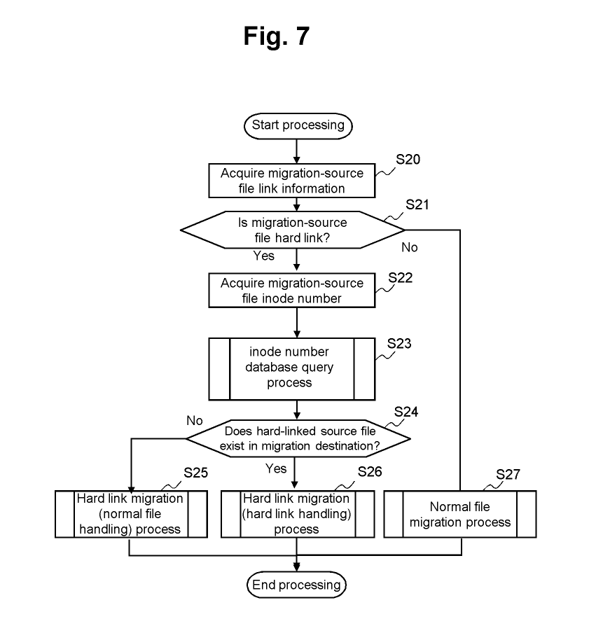

FIG. 7 is a flowchart showing an example of a migration process related to Example 1.

This migration process corresponds to Step S13 of FIG. 6, and is executed by the migration processing program 124 of the migration-destination file server 10.

The migration processing program 124 of the migration-destination file server 10 acquires link information (the number of links) in the inode 160 of the migration-target file (migration-source file) from the migration-source file server 20 (Step S20).

Next, the migration processing program 124, based on the number of links, determines whether or not the migration-source file is a hard link (Step S21).

Specifically, the migration processing program 124 determines that the migration-source file is a hard link in a case where the number of links is equal to or larger than 2. This makes it possible to appropriately determine whether the migration-source file is a hard link or not.

In a case where the result is that the migration-source file in not a hard link (Step S21: No), the migration processing program 124 executes a migration process for a normal file (normal file migration process) (Step S27).

Alternatively, in a case where the migration-source file is a hard link (Step S21: Yes), the migration processing program 124 acquires the inode number of the migration-source file inode 160 (Step S22), and makes the inode number database query program 125 to execute an inode number database query process (refer to FIG. 8) using the acquired inode number (Step S23).

According to this inode number database query process, a determination result is obtained as to whether or not a hard link (link-source file), which references a file entity which corresponds to a file entity referenced by this acquired inode number and migrated to this migration-destination file system, exists in the migration-destination file system. Specifically, a determination result is obtained as to whether a file entity related to the acquired inode number has been already sent to the migration-destination file system.

Next, the migration processing program 124, based on the result of the inode number database query process, determines whether or not a link-source file exists in the migration-destination file server 10 (Step S24), and in a case where a link-source file does not exist in the migration-destination file server 10 (Step S24: No), has the hard link migration (normal file handling) program 126 execute a hard link migration (normal file handling) process (Refer to FIG. 9) (Step S25). Alternatively, in a case where a link-source file exists in the migration-destination file server 10 (Step S24: Yes), the migration processing program 124 has the hard link migration (hard link handling) program 127 execute a hard link migration (hard link handling) process (Refer to FIG. 10) (Step S26).

Then, after the processing of Steps S25, S26, and S27 has ended, the migration processing program 124 ends the migration process.

FIG. 8 is a flowchart showing an example of an inode number database query process related to Example 1.

This inode number database query process corresponds to Step S23 of FIG. 7, and is executed by the inode number database query program 125 of the migration-destination file server 10.

The inode number database query program 125 conducts a search to determine whether or not a directory having the migration-source file inode number as its name exists subordinate to a dedicated hard link migration directory 1221 of an index tree 1220 (Step S30). Next, the inode number database query program 125 determines whether or not a directory having the migration-source file inode number was retrieved (Step S31). In a case where a directory having the migration-source file inode number exists (Step S31: Yes), determines that a hard link (referred to as a link-source file or a dummy file), which references a file entity of the migration-destination file system, corresponding to a file entity referenced using this inode number, exists in the dedicated hard link migration directory 1221 (Step S32). Alternatively, in a case where a directory having the migration-source file inode number does not exist (Step S31: No), the inode number database query program 125 determines that a link-source file does not exist (Step S33). This makes it possible to appropriately determine whether a link-source file exists or not. Thereafter, the inode number database query program 125 ends this inode number database query process.

FIG. 9 is a flowchart showing an example of a hard link migration (normal file handling) process related to Example 1.

This hard link migration (normal file handling) process corresponds to Step S25 of FIG. 7, and is executed by the hard link migration (normal file handling) program 126 of the migration-destination file server 10.

The hard link migration (normal file handling) program 126 migrates a migration-source file to the migration-destination file system (Step S40). Specifically, the hard link migration (normal file handling) program 126 acquires a file entity of the migration-source file from the migration-source file system, stores the relevant entity file in the user data storage apparatus 150 of the migration-destination file server 10. Then the hard link migration (normal file handling) program 126 creates an inode 160 for the file corresponding to the migration-source file in the migration-destination file system and stores this inode 160 in the user data storage apparatus 150. Thereafter, the hard link migration (normal file handling) program 126 associatively stores the filename of the migration-source file in the directory file 181 corresponding to the migration-destination directory in the migration-destination file system 122 with the inode number in the migration-destination file system 122 of the file corresponding to the relevant migration-source file. In addition, the hard link migration (normal file handling) program 126 associatively stores this inode number and data block information, which denotes an address of a data block of the user data storage apparatus 150 where the file entity is stored, in the inode list 170 of the migration-destination file system. The inode number of the migrated file in the migration-destination file system may be different from the inode number thereof in the migration-source file system.

Next, the hard link migration (normal file handling) program 126 creates a directory 1222, which has as its directory name the inode number of the migration-source file system associated with the migration-source file, subordinate to the dedicated hard link migration directory 1221 in the migration-destination file system 122 (Step S41). The directory name of the created directory 1222 is not limited to the inode number as long as the name clearly corresponds to the inode number.

Next, the hard link migration (normal file handling) program 126 creates a hard link (link-source file or a dummy file) 1223 associated with the inode number in the migration-destination file system of the migration-source file subordinate to the directory 1222 created in Step S41 (Step S42). Specifically, the hard link migration (normal file handling) program 126 associatively stores a prescribed name allocated to a link-source file (or a dummy file) with the inode number in the migration-destination file system of the migration-source file in the directory file 181 corresponding to the directory 1222 of the index tree 1220 in the migration-destination file system 122. In this example, in Step S42, the hard link migration (normal file handling) program 126 creates one less link-source file 1223 than the number of links included in the inode 160 of the migration-source file in the migration-source file system 122. This makes it possible to appropriately create the same number of link-source files 1223 as the number of unmigrated hard links referencing the same file entity in the migration-source file system. Thereafter, the hard link migration (normal file handling) program 126 ends the hard link migration (normal file handling) process.

FIG. 10 is a flowchart showing an example of a hard link migration (hard link handling) process related to Example 1.

This hard link migration (hard link handling) process corresponds to Step S26 of FIG. 7, and is executed by the hard link migration (hard link handling) program 127 of the migration-destination file server 10.

The hard link migration (hard link handling) program 127 reads a directory file 181 of the directory, which has the inode number of the migration-source file in the index tree 1220 as its name (Step S50).

Next, the hard link migration (hard link handling) program 127 acquires the filename of a directory-subordinate file stored in the read directory file 181, that is, one filename of a link-source file (Step S51).

Next, the hard link migration (hard link handling) program 127 renames the link-source file path as the migration-destination path of the migration-source file (Step S52). Thereafter, the hard link migration (hard link handling) program 127 ends the hard link migration (hard link handling) process. According to this example, since renaming the path of the link-source file 1223 created beforehand changes this link-source file to a migration-destination file, it is possible to migrate the hard link, which is the migration-source file, to the migration-destination file system without a hitch, even when another migration-destination file system hard-linked file, which references the same file entity is deleted or renamed. Also, since the link-source file 1223 is stored in the directory having the inode number of the migration-source file as its name, the link-source file 1223 search time can be shortened since a search can be performed on the basis of the migration-source file inode number. Furthermore, since it is not necessary to manage information denoting a directory name in a migration-source file system inode, it is also possible to hold down on the size of the inode 160.

FIG. 11 is a diagram illustrating a rename process related to Example 1. FIG. 11 shows an example of a rename process in a case where a file having the full pathname “/home/FileA” is renamed to “/etc/FileA” in the file system.

First, the file system 122 adds a combination of an inode number (in this example, “200”) and the filename of the rename-target file (in this example, “FileA”) to the directory file 181 of the rename-destination “etc” directory (FIG. 11 (1)). Next, the file system 122 deletes a combination of the filename of the rename-target file (in this example, “FileA”) and the inode number thereof (in this example, “200”) from the directory file 181 of the rename-source “home” directory (FIG. 11 (2)).

According to this rename process, whereas prior to renaming it was possible to access a file entity by identifying the inode number “200” using the pathname “home/FileA”, it has now become possible to access the same file entity by identifying the inode number “200” using the pathname “etc/FileA”.

The link-source file path is renamed as the migration-destination path of the migration-source file in the same manner as the rename process described above.

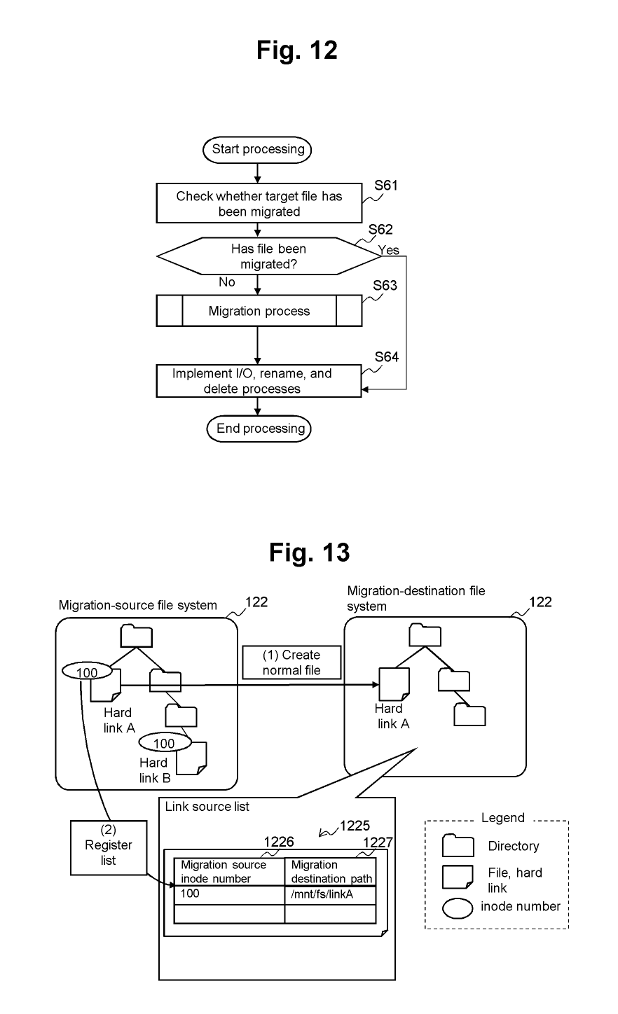

FIG. 12 is a flowchart showing an example of an I/O, rename, and delete process during migration related to Example 1.

The I/O, rename, and delete process is executed in a case where an I/O, a rename, or a delete request has been generated with respect to a file during a migration from the migration-source file system to the migration-destination file system.

The migration management program 123, upon receiving an I/O, a rename, or a delete request, checks whether or not the request-target file has been migrated (Step S61). Whether or not the request-target file has been migrated can be checked here by referencing the inode list 170 and the directory file 181 of the data block 180 in the file system 122 and checking whether or not a corresponding file exists.

Next, the migration management program 123 determines whether or not the request-target file has been migrated (Step S62), and in a case where the request-target file has not been migrated (Step S62: No), has the migration processing program 124 execute the migration process shown in FIG. 7 by treating the request-target file as the migration-target file (Step S63), and advances the processing to Step S64. Alternatively, in a case where the request-target file has been migrated (Step S62: Yes), the migration management program 123 advances the processing to Step S64. Thus, when performing migration processing for a file targeted in a request, it is possible to get by without performing migration processing for a file that does not require it, and to reduce wasteful throughput. In Step S64, the migration management program 123 implements the processing (I/O, rename, or delete processing) requested for the request-target file (Step S64), and ends the I/O, rename and delete process.

According to the I/O, rename, and delete process, I/O, rename, or delete processing can be appropriately executed after the request-target file has been migrated to the migration-destination file system 122 in a case where the file has not been migrated, and immediately in a case where the file is a request-target file which has been migrated. Even in a case where the request-target file is a hard link, and another hard link, which references the same file entity, has not been migrated, because a link-source file 1223 is prepared in accordance with the hard link migration (normal file handling) process shown in FIG. 9, it is possible to use this link-source file to appropriately migrate the unmigrated hard link to the migration-destination file system even after the request-target file has been deleted or renamed.

Next, Example 2 will be explained.

First, an overview of a computer system related to Example 2 will be explained.

Whereas the computer system related to Example 1 used an index tree 1220 to perform file system migration, the computer system related to Example 2 uses a link source list to perform file system migration.

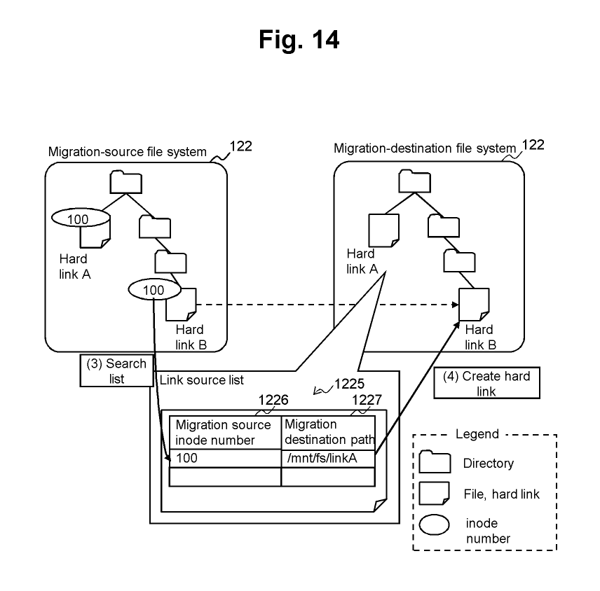

FIG. 13 is a first diagram showing an overview of a file system migration process related to Example 2. FIG. 14 is a second diagram showing an overview of the file system migration process related to Example 2. FIGS. 13 and 14 here show examples of a case in which a migration-source file system 122 of a migration-source file server 20 is migrated to a migration-destination file system 122 of a migration-destination file server 10.

A hard link A and a hard link B, which reference the same physical storage area (that is, the same file entity), are managed in the migration-source file system 122. The hard link A and the hard link B are managed here as having (referencing) the same inode number (“100” here).

First, in a case where the hard link A is migrated to the migration-destination file system, the migration-destination file server 10 migrates the hard link A to the migration-destination file system 122 the same as a normal file migration as shown in FIG. 13 (1). Specifically, the migration-destination file server 10 stores the file entity referenced by the hard link A in a user data storage apparatus 150 of the migration-destination file server 10, creates and stores an inode corresponding to the hard link A, associatively registers the hard link A filename with the migration-destination file system 122 inode number allocated to the relevant hard link A in a directory file corresponding to a migration-destination directory in the migration-destination file system 122, and associatively stores the allocated inode number and data block information showing the address of the data block, which stores the file entity, in an inode list 170.

Next, as shown in FIG. 13 (2), the migration-destination file server 10 registers the migration-source file system inode number (the migration-source inode number, which is “100” here) 1226 associated with the migration-target hard link A and the relevant hard link A migration destination path (migration-destination path) 1227 in the migration-destination file system in a link source list 1225. The migration-destination file server 10, in a case where the migration-destination path file registered in the link source list 1225 has been renamed, manages the migration-destination path 1227 of the link source list 1225 by changing the post-rename pathname. Therefore, the hard link A can be appropriately identified even in a case where the path of the migrated hard link A has been changed.

Thereafter, in a case where the hard link B for referencing the same file entity as the hard link A is migrated to the migration-destination file system, as shown in FIG. 14 (3), the migration-destination file server 10 uses the hard link B migration-source inode number to identify the migration-destination path via which the hard link A having the same migration-source inode number has been migrated, by searching the link source list 1225.

Next, the migration-destination file server 10, as shown in FIG. 14 (4), creates the hard link B in the migration-destination file system by identifying the inode number associated with the identified migration-destination path file in the migration-destination file system 122, and registering information, which associates the relevant identified inode number with the hard link B filename, in the directory file 181 of the hard link B migration-destination directory. This makes it possible to reference the same file entity as the hard link A since the inode number in the same migration-destination file system as the hard link A is associated with the hard link B.

Next, the configuration of the computer system related to Example 2 will be explained. The computer system related to Example 2 basically constitutes the same configuration as the computer system related to Example 1, the same reference signs will be used for the same parts, and the parts that differ will be explained here.

The migration-destination file server 10, as shown in FIG. 13, does not manage an index tree 1220, but rather manages a link source list 1225. The link source list 1225, for example, is stored in the user data storage apparatus 150 of the migration-destination file server 10.

The link source list 1225 stores entries, which associate a migration-source file system inode number (migration-source inode number) 1226 of the earliest hard link migrated from among multiple hard links referencing the same file entity with a migration-destination file system migration destination path (migration-destination path) 1227 for this hard link.

Next, processing using the computer system related to Example 2 will be explained.

The same process as the entire file system migration process related to Example 1 shown in FIG. 6 is performed in the computer system related to Example 2.

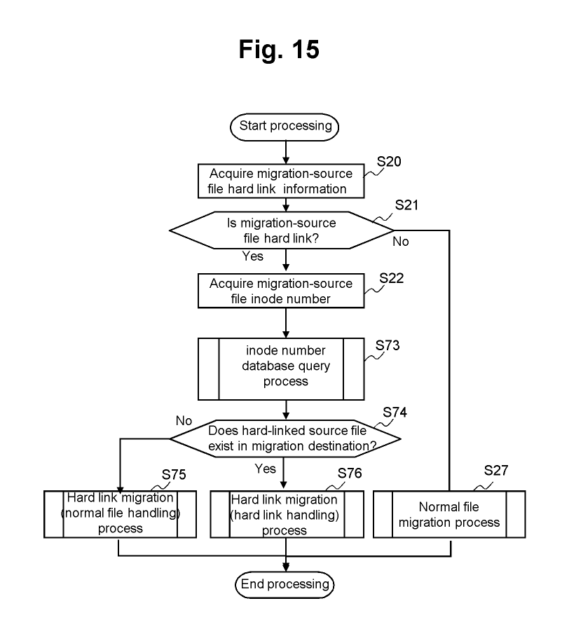

FIG. 15 is a flowchart showing an example of a migration process related to Example 2. The same reference signs will be given to processing steps, which are the equivalent to those of the migration process related to Example 1 shown in FIG. 7, and duplicate explanations will be omitted.

This migration process corresponds to Step S13 of FIG. 6, and is executed by the migration processing program 124 of the migration-destination file server 10.

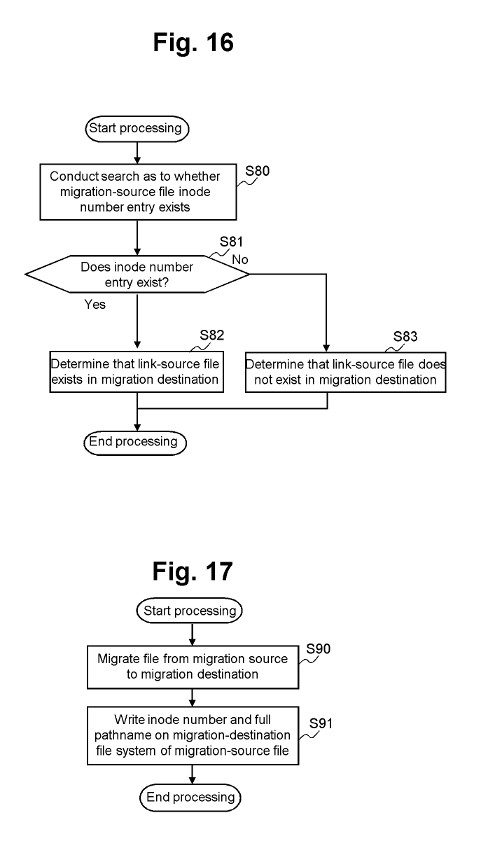

Upon acquiring the inode number of the migration-source file inode 160 in Step S22, the migration processing program 124 has the inode number database query program 125 execute an inode number database query process (refer to FIG. 16) using the acquired inode number (Step S73).

According to this inode number database query process, a determination result is obtained as to whether or not a hard link (link-source file), which corresponds to a file entity referenced by this inode number and references a file entity migrated to this migration-destination file system, exists in the migration-destination file system.

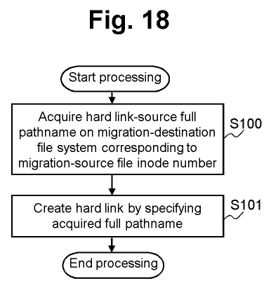

Next, the migration processing program 124, based on the result of the inode number database query process, determines whether or not a link-source file exists in the migration-destination file server 10 (Step S74), and in a case where a link-source file does not exist in the migration-destination file server 10 (Step S74: No), has the hard link migration (normal file handling) program 126 execute a hard link migration (normal file handling) process (Refer to FIG. 17) (Step S75). Alternatively, in a case where a link-source file exists in the migration-destination file server 10 (Step S74: Yes), the migration processing program 124 has the hard link migration (hard link handling) program 127 execute a hard link migration (hard link handling) process (Refer to FIG. 18) (Step S76).

Then, after the processing of Steps S75, S76, and S27 has ended, the migration processing program 124 ends the migration process.

FIG. 16 is a flowchart showing an example of an inode number database query process related to Example 2.

The inode number database query process corresponds to Step S73 of FIG. 15, and is executed by the inode number database query program 125 of the migration-destination file server 10.

The inode number database query program 125 conducts a search to determine whether or not an entry corresponding to the migration-source file inode number exists in the link source list 1225 (Step S80).

Next, the inode number database query program 125 determines whether or not an entry corresponding to the migration-source file inode number was retrieved (Step S81), and in a case where an entry corresponding to the migration-source file inode number exists (Step S81: Yes), determines that a hard link (referred to as ink-source file) referencing a migration-destination file system file entity, which corresponds to the file entity referenced in accordance with this inode number, exists in the migration-destination file system (Step S82). Alternatively, in a case where an entry for the migration-source file inode number does not exist (Step S81: No), the inode number database query program 125 determines that a link-source file does not exist (Step S83). Thereafter, the inode number database query program 125 ends this inode number database query process.

FIG. 17 is a flowchart showing an example of a hard link migration (normal file handling) process related to Example 2.

The hard link migration (normal file handling) process corresponds to Step S75 of FIG. 15, and is executed by the hard link migration (normal file handling) program 126 of the migration-destination file server 10.

The hard link migration (normal file handling) program 126 migrates a migration-source file to the migration-destination file system (Step S90). Specifically, the hard link migration (normal file handling) program 126 acquires a file entity of the migration-source file from the migration-source file system, stores the relevant entity file in the user data storage apparatus 150 of the migration-destination file server 10, creates and stores in the migration-destination file system an inode 160 for a file corresponding to the migration-source file, associatively registers in the migration-destination file system 122 a filename of the migration-source file in the directory file 181 corresponding to the migration-destination directory and the inode number in the migration-destination file system 122 of the file corresponding to the relevant migration-source file, and associatively stores this inode number with data block information denoting the data block address of the user data storage apparatus 150, which stores the file entity, in the migration-destination system inode list 170.

Next, the hard link migration (normal file handling) program 126 writes in the link source list 1225 an entry, which associates the migration-source file system inode number, which is associated with the migration-source file, with the full pathname in the migration-destination file system of the relevant migration-source file (Step S91). Thereafter, the hard link migration (normal file handling) program 126 ends the hard link migration (normal file handling) process.

FIG. 18 is a flowchart showing an example of a hard link migration (hard link handling) process related to Example 2.

The hard link migration (hard link handling) process corresponds to Step S76 of FIG. 15, and is executed by the hard link migration (hard link handling) program 127 of the migration-destination file server 10.

The hard link migration (hard link handling) program 127 acquires a full pathname corresponding to the migration-source file inode number from the link source list 1225 (Step S100).

Next, the hard link migration (hard link handling) program 127 acquires the inode number of the file corresponding to the acquired full pathname, and creates a hard link by associatively registering the acquired inode number with the filename of the relevant migration-source file in the directory file 181 of the directory corresponding to migration destination full pathname of the migration-source file (Step S101).

Thereafter, the hard link migration (hard link handling) program 127 ends the hard link migration (hard link handling) process.

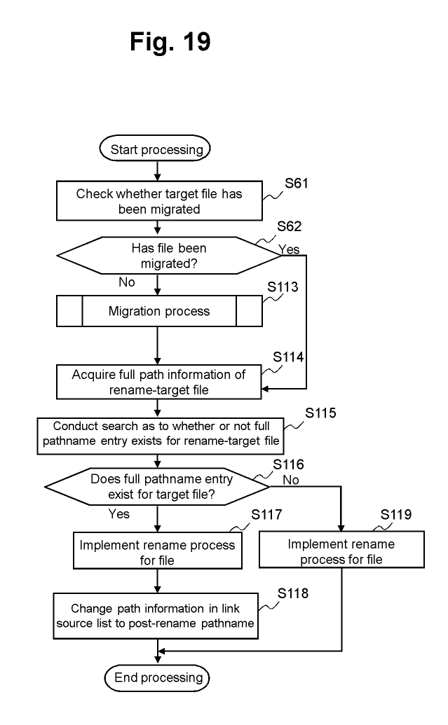

FIG. 19 is a flowchart showing an example of a rename process during migration related to Example 2. The same reference signs will be given to the equivalent processing steps to those in the I/O, rename, and delete process related to Example 1 shown in FIG. 12, and duplicate explanations will be omitted.

The rename process is executed in a case where a rename request has been generated with respect to a file which is in the process of being migrated from the migration-source file system to the migration-destination file system.

In a case where the result of the determination of Step S62 is that the request-target file has not been migrated (Step S62: No), the migration management program 123 has the migration processing program 124 execute the migration process shown in FIG. 15 having the request-target file as the migration-target file (Step S113), and advances the processing to Step S114. Alternatively, in a case where the request-target file has been migrated (Step S62: Yes), the migration management program 123 advances the processing to Step S114.

In Step S114, the migration management program 123 acquires the full pathname of the request-target file. Next, the migration management program 123 conducts a search to determine whether or not a full pathname entry for the request-target file exists in the link source list 1225 (Step S115), and determines whether or not the full pathname entry for the request-target file exists (Step S116).

A case in which the result is that a full pathname entry exists for the request-target file (Step S116: Yes) signifies that the request-target file is a hard link, and as such, the migration management program 123 implements a rename process with respect to the request-target file (Step S117), changes the pathname of the request-target file in the link source list 1225 to the post-rename pathname (Step S118), and ends the rename-during-migration process. Alternatively, a case in which a full pathname entry does not exist for the request-target file (Step S116: No) signifies that the request-target file is not a hard link, and as such, the migration management program 123 implements the rename process with respect to the request-target file (Step S119) and ends the rename process during migration.

According to the above-described rename process during migration, in a case where a rename process is performed for a hard link migrated to the migration-destination file system 122, the post-rename pathname of the relevant hard link is stored in the link source list 1225. Therefore, in a case where another hard link referencing the same file entity is migrated to the migration-destination file system, it is possible to use the hard link migration (hard link handling) process shown in FIG. 18 to acquire the latest full pathname of the migrated hard link corresponding to the migration-source file inode number from the link source list 1225, and to create a hard link corresponding to the migration-source file by acquiring the inode number of the file corresponding to the acquired full pathname.

A number of examples have been explained hereinabove, but it goes without saying that the present invention is not limited to these examples, and that various changes are possible without departing from the gist thereof.

### REFERENCE SIGNS LIST

10 Migration-destination file server
20 Migration-source file server
40 Client
100 File storage apparatus
150 User data storage apparatus

1. A migration-destination file server, which is coupled to a migration-source file server that provides a migration-source file system, and which provides a migration-destination file system, the migration-destination file server comprising:
a storage device; and
a controller,
wherein when migrating a first hard-linked file, which is included in multiple hard-linked files referencing the same file management information in the migration-source file system, to the migration-destination file system, the controller stores data related to the first hard-linked file in the storage device, creates the first hard-linked file in the migration-destination file system, and creates a dummy hard-linked file for referencing the same file management information as the first hard-linked file in the migration-destination file server, and
when migrating a second hard-linked file included in the multiple hard-linked files, the controller renames the dummy hard-linked file as a pathname of the second hard-linked file in the migration-destination file system.

2. A migration-destination file server according to claim 1, wherein the controller acquires the number of links to data related to a migration-target file from the migration-source file server, and in a case where there are multiple links, identifies that the migration-target file is a hard-linked file.

3. A migration-destination file server according to claim 2, wherein in a case where the identified hard-linked file is the first hard-linked file, the controller creates a directory having a name which corresponds to a file management information identifier denoting the file management information of the first hard-linked file in the migration-source file system, and
creates, directly subordinate to the created directory, the dummy hard-linked file for referencing the same file management information as the first hard-linked file.

4. A migration-destination file server according to claim 3, wherein the controller determines whether the hard-linked file is the first hard-linked file or the second hard-linked file based on whether or not there has been created in the migration-destination file system a directory having a name corresponding to the file management information identifier denoting the file management information of the identified hard-linked file in the migration-source file system.

5. A migration-destination file server according to claim 2, wherein the controller creates one less dummy hard-linked file referencing the same file management information as the first hard-linked file than the number of links to data related to the first hard-linked file.

6. A migration-destination file server according to claim 2, wherein the migration-source file system is configured as read only with respect to a file during the migration of the file from the migration-source file system to the migration-destination file system.

7. A migration-destination file server according to claim 1, wherein during the migration of the file from the migration-source file system to the migration-destination file system, the controller accepts a specification for a request-target file, which is a target of an input/output request, a rename request, or a delete request, and
in a case where the request-target file has not yet been migrated to the migration-destination file system, migrates the request-target file from the migration-source file system to the migration-destination file system.

8. A file system migration method by a migration-destination file server, which is coupled to a migration-source file sever that provides a migration-source file system, and which provides a migration-destination file system, the file system migration method comprising:
upon migrating a first hard-linked file, which is included in multiple hard-linked files referencing the same file management information in the migration-source file system, to the migration-destination file system, storing data related to the first hard-linked file in the storage device, creating the first hard-linked file in the migration-destination file system, and creating a dummy hard-linked file for referencing the same file management information as the first hard-linked file in the migration-destination file server; and
upon migrating a second hard-linked file included in the multiple hard-linked files, renaming the dummy hard-linked file as a pathname of the second hard-linked file in the migration-destination file system.

9. A file system migration method according to claim 8, further comprising:
acquiring the number of links to data related to a migration-target file from the migration-source file server, and identifying that the migration-target file is a hard-linked file in a case where there are multiple links.

10. A file system migration method according to claim 9, further comprising:
creating a directory having a name which corresponds to a file management information identifier denoting the file management information of the first hard-linked file in the migration-source file system, in a case where the identified hard-linked file is the first hard-linked file; and
creating, directly subordinate to the created directory, the dummy hard-linked file for referencing the same file management information as the first hard-linked file.

11. A file system migration method according to claim 10, further comprising:
determining whether the hard-linked file is the first hard-linked file or the second hard-linked file based on whether or not there has been created in the migration-destination file system a directory having a name corresponding to the file management information identifier denoting the file management information of the identified hard-linked file in the migration-source file system.

12. A file system migration method according to claim 9, further comprising:
creating one less dummy hard-linked file referencing the same file management information as the first hard-linked file than the number of links to data related to the first hard-linked file.

13. A file system migration method according to claim 9, further comprising:
configuring the migration-source file system to read only with respect to a file, during the migration of the file from the migration-source file system to the migration-destination file system.

14. A file system migration method according to claim 8, further comprising:
accepting a specification for a request-target file, which is a target of an input/output request, a rename request, or a delete request, during the migration of the file from the migration-source file system to the migration-destination file system; and
migrating the request-target file from the migration-source file system to the migration-destination file system in a case where the request-target file has not yet been migrated to the migration-destination file system.
